(19) United States
(12) Patent Application Publication
(10) Pub. No.: US 2002/0109567 A1
(43) Pub. Date: Aug. 15, 2002

(54) Dielectric filter, dielectric duplexer, and communication device

(75) Inventors: Katsuhito Kuroda, Matsutou-shi (JP); Hirofumi Miyamoto, Kanazawa-shi (JP); Jinsei Ishihara, Kanazawa-shi (JP); Hideyuki Kato, Ishikawa-gun (JP)

Correspondence Address: OSTROLENK FABER GERB & SOFFEN, 1180 AVENUE OF THE AMERICAS, NEW YORK, NY, 100368403

(73) Assignee: Murata Manufacturing Co., Ltd.

(21) Appl. No.: 10/076,724

(22) Filed: Feb. 13, 2002

(30) Foreign Application Priority Data
Feb. 14, 2001 (JP) 2001-036968

(51) Int. Cl. H01P 1/202

(52) U.S. Cl. 333/206

(57) ABSTRACT

A dielectric filter which has suitable attenuation characteristics and which readily exhibits desired characteristics. First, second and third inner-conductor holes having an inner conductor on each of the surfaces thereof are formed inside a dielectric block having an outer conductor on the outer surface thereof. First and second I/O electrodes extend from opposing side-surfaces to the undersurface of the dielectric block and are separated from the outer conductor. The side-surfaces are orthogonal to the direction in which the inner-conductor holes are arrayed in the dielectric block, and the undersurface is a mounting surface for facing a mounting board. The first I/O electrode extends from one of said side-surfaces near the first inner-conductor hole, to a position beyond a remote side of the second inner-conductor hole, that is, the side near the third inner-conductor hole.

### BACKGROUND OF THE INVENTION

1. Field of the Invention

The present invention relates to a dielectric filter and a dielectric duplexer which comprise a dielectric block having holes with conductors formed on the surfaces of the holes (hereinafter referred to as inner-conductor holes) and an outer conductor on the outer surface of the dielectric block, and to a communication device using the dielectric filter and the dielectric duplexer.

2. Description of the Related Art

A known dielectric filter having a substantially rectangular parallelepiped dielectric block will now be described with reference to FIGS. 7A and 7B.

FIG. 7A is a perspective view of the dielectric filter, and FIG. 7B is a leftside elevational view of the same.

In FIGS. 7A and 7B, the dielectric filter includes a dielectric block 1, inner-conductor holes 2a, 2b, 2c, and 2d, inner conductors 3a, 3b, 3c, and 3d, an outer conductor 4, input and output (I/O) electrodes 5a and 5b, and dielectric resonators 6a, 6b, 6c, and 6d.

Inside the dielectric block 1, the inner-conductor holes 2a to 2d, which have the inner conductors 3a to 3c on the surfaces thereof, form resonators. On the outer surface of the dielectric block 1, the outer conductor 4 forms a ground electrode. In this manner, the inner-conductor holes 2a to 2d and the outer conductor 4 form the dielectric resonators 6a to 6d. On the outer surface of the dielectric block 1, the I/O electrode 5a is formed separate from the outer conductor 4 and is coupled with the dielectric resonator 6a (hereinafter referred to as the resonator), and the I/O electrode 5b is formed separate from the outer conductor 4 and is coupled with the resonator 6d, whereby the dielectric filter is formed.

However, dielectric filters using the known dielectric blocks have the problems described below.

Generally, bandpass filters must obtain a predetermined attenuation far outside the pass band. To this end, an attenuation pole is provided in the attenuation region of the bandpass filters.

In the known dielectric filter, the I/O electrode 5a is coupled with the resonator 6a and the I/O electrode 5b is coupled with the resonator 6d. Since the amount of coupling between the resonator 6a and the resonator 6b, and between the resonator 6c and the resonator 6d is small, the resonators are not sufficiently capacitively coupled. Therefore, an effective attenuation pole is not obtained. To obtain a sufficient amount of coupling, a capacitor must be provided between the resonator 6a and the resonator 6b, and between the resonator 6c and the resonator 6d. Accordingly, the manufacturing costs increase due to the increase in the number of parts, and the reliability deteriorates because of the increase in the number of connections.

In Japanese Unexamined Patent Application Publication No. 5-145302, a dielectric filter in which an attenuation pole is provided in the vicinity of the pass band thereof is disclosed.

The dielectric filter comprises a dielectric block having a plurality of dielectric resonators. The dielectric block has I/O electrodes on the outer surface thereof, which are coupled with the plurality of dielectric resonators. According to this configuration, since the amount of coupling between the plurality of resonators and between the plurality of resonators and the I/O electrodes becomes large, the attenuation region is provided with a pole, making the attenuation curve steeper by forming an attenuation pole near the pass band. Thus, a bandpass filter capable of sufficiently attenuating unwanted signals is provided.

In the above-described dielectric filter, however, the size of the I/O electrodes may vary according to manufacturing tolerances. In such a case, the amount of coupling between the second resonator and the I/O electrode varies, rendering the attenuation characteristics unstable.

Also, when the width of the I/O electrodes (the dimension of the I/O electrodes parallel to the axes of the inner-conductor holes) is large, the Qo factor of the resonators deteriorates, and the insertion loss increases. Further, since the width of the I/O electrodes is fixed, a dielectric filter formed in a certain shape exhibits only one kind of attenuation characteristic. In other words, the dielectric filter is not capable of exhibiting a plurality of attenuation characteristics for achieving desired characteristics.

### SUMMARY OF THE INVENTION

Accordingly, the present invention provides a dielectric filter and a dielectric duplexer, which exhibit suitable attenuation characteristics and which readily obtain desired characteristics, and provides a communication device using the dielectric filter and the dielectric duplexer.

To this end, according to an aspect of the present invention, there is provided a dielectric filter comprising a substantially rectangular parallelepiped dielectric block, a plurality of inner-conductor holes extending from a first main surface to an opposing second main surface of the dielectric block, an inner conductor provided on the surface of each of the inner-conductor holes, an outer conductor formed on outer surfaces of the dielectric block, and I/O electrodes extending from side-surfaces to an undersurface of the dielectric block. The side-surfaces are orthogonal to the direction in which the inner-conductor holes are arrayed in the dielectric block, and the undersurface is a mounting surface for facing a mounting board. The I/O electrodes are separated from the outer conductor. Further, at least one of the I/O electrodes extends across portions of the undersurface of the dielectric block adjacent to at least two of the inner-conductor holes when viewed from the undersurface. The dielectric filter obtained according to this configuration exhibits stable and suitable attenuation characteristics.

In one form of the invention, the width of the one of the I/O electrodes is different between a first region corresponding to the first inner-conductor hole and a second region corresponding to the second inner-conductor hole when viewed from the undersurface. According to this configuration, a dielectric filter is obtained, which readily obtains desired attenuation characteristics.

The width at the first region may be larger than the width at the second region. According to this configuration, a dielectric filter is obtained, which readily obtains desired attenuation characteristics.

The width at the first region may be smaller than the width at the second region. According to this configuration as well, a dielectric filter is obtained, which readily obtains desired attenuation characteristics.

According to another aspect of the present invention, there is provided a dielectric duplexer comprising the dielectric filter. According to this configuration, the dielectric duplexer exhibits desired characteristics, and stable and suitable attenuation characteristics are achieved.

According to another aspect of the present invention, there is provided a communication device comprising the dielectric filter. According to this configuration, the communication device exhibits suitable communication characteristics.

Other features and advantages of the present invention will become apparent from the following description of embodiments of the invention which refers to the accompanying drawings.

### BRIEF DESCRIPTION OF THE DRAWINGS

FIG. 1A is a perspective view of a dielectric filter according to a first embodiment;

FIG. 1B is an elevational view of the dielectric filter according to the first embodiment;

FIG. 2A is an equivalent circuit diagram of the dielectric filter according to the first embodiment;

FIG. 2B is an equivalent circuit diagram of the dielectric filter according to the first embodiment;

FIG. 3A is a perspective view of a dielectric filter according to a second embodiment;

FIG. 3B is an elevational view of the dielectric filter according to the second embodiment;

FIG. 4A is a perspective view of another dielectric filter according to the second embodiment;

FIG. 4B is an elevational view of the other dielectric filter according to the second embodiment;

FIG. 5A is a perspective view of a dielectric duplexer according to a third embodiment;

FIG. 5B is an elevational view of the dielectric duplexer according to the third embodiment;

FIG. 6 is a block diagram of a communication device according to a fourth embodiment;

FIG. 7A is a perspective view of a known dielectric filter; and

FIG. 7B is an elevational view of the known dielectric filter.

### DESCRIPTION OF EMBODIMENTS OF THE INVENTION

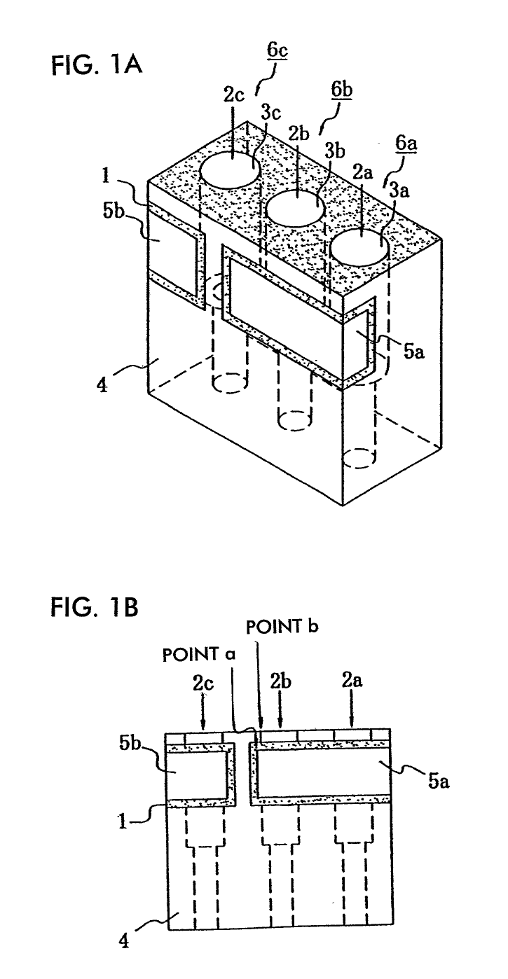

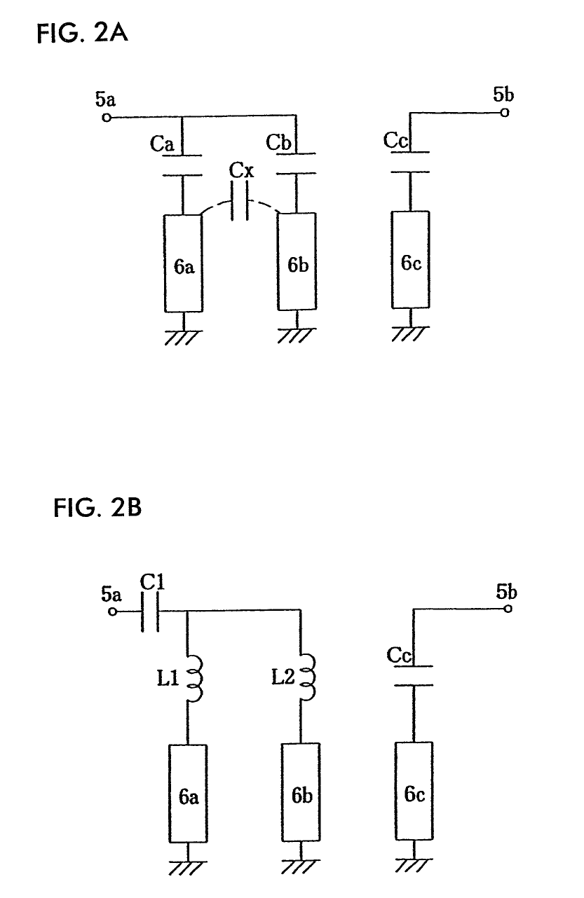

It is to be noted that like parts are designated by like reference numerals throughout the accompanying drawings. With reference to FIGS. 1A and 1B and FIGS. 2A and 2B, a dielectric filter according to a first embodiment will now be described.

FIG. 1A is a perspective view of the dielectric filter, and FIG. 1B is an elevational view of the same.

In FIGS. 1A and 1B, the dielectric filter includes a dielectric block 1, inner-conductor holes 2a, 2b and 2c, inner conductors 3a, 3b and 3c, an outer conductor 4, input and output (I/O) electrodes 5a and 5b, and dielectric resonators (hereinafter referred to as resonators) 6a, 6b and 6c.

Inside the dielectric block 1, the inner-conductor holes 2a to 2c, which have the inner conductors 3a to 3c formed on the surfaces thereof, form resonators. On the outer surface of the dielectric block 1, the outer conductor 4 is formed as a ground electrode. The inner-conductor holes 2a to 2c and the outer electrode 4 constitute the resonators 6a to 6c. The I/O electrode 5a extends from one side-surface to the undersurface of the dielectric block 1 and is separated from the outer conductor 4. The side-surfaces are orthogonal to the direction in which the inner-conductor holes are arrayed, and the undersurface is the surface shown in FIG. 1A when viewed from the left side, which faces a mounting board (not shown) when the dielectric filter is mounted. The I/O electrode 5b extends from the other side-surface to the undersurface of the dielectric block 1 and is separated from the outer conductor 4.

As shown in FIG. 1B, the I/O electrode 5a on the undersurface extends to a point a that is beyond a point b corresponding to the side of the inner-conductor hole 2b near the inner-conductor hole 2c.

Further, in this embodiment, the resonators 6a to 6c are aligned so that the resonator 6b is positioned to the left of the resonator 6a, and the resonator 6c is positioned to the left of the resonator 6b when viewed from the undersurface.

Hence, the I/O electrode 5a is coupled with the inner-conductor holes 2a and 2b. It also means that the I/O electrode 5a is coupled with the resonators 6a and 6b.

FIG. 2A shows an equivalent circuit diagram of the dielectric filter shown in FIGS. 1A and 1B. FIG. 2B shows an equivalent circuit diagram obtained by converting the equivalent circuit shown in FIG. 2A.

In FIGS. 2A and 2B, reference numerals 5a and 5b denote the I/O electrodes of the dielectric filter, and reference numerals 6a, 6b and 6c denote the resonators. Further, reference numerals Ca, Cb, Cc, Cx, and C1 denote capacitances, and reference numerals L1 and L2 denote inductances.

As shown in FIG. 2A, the capacitance Ca connects the I/O electrode 5a with the resonator 6a, and the capacitance Cb connects the I/O electrode 5a with the resonator 6b. Further, the capacitance Cx connects the resonator 6a and the resonator 6b, and the capacitance Cc connects the I/O electrode 5b with the resonator 6c.

Since the circuit shown in FIG. 2A is a closed, D-shaped circuit comprising the three capacitances Ca, Cb and Cx, the circuit may be considered equivalent to a Y-shaped circuit as shown in FIG. 2B. A series resonance is generated by the resonator 6a and the inductor L1, whereby an attenuation pole is formed at a high frequency of the pass band.

Since the I/O electrode 5a extends beyond the position corresponding to one side of the resonator 6b, that is, the end near the resonator 6c, the capacitance Cb becomes stable even when dimensional variations occur. Therefore, an attenuation pole is formed stably. Since the capacitance Cb is provided without enlarging the width of the I/O electrode 5a, deterioration of the Qo factor and insertion loss is reduced.

Hence, the dielectric filter exhibits stable and suitable attenuation characteristics.

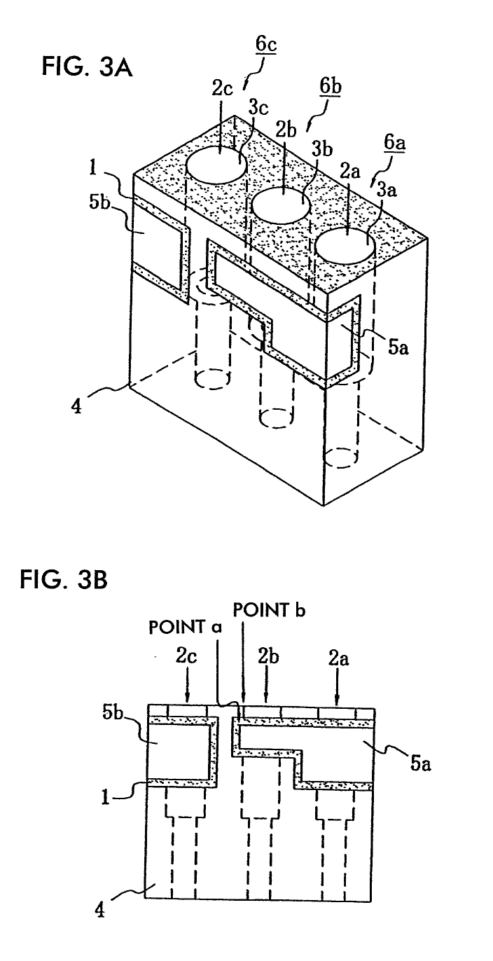

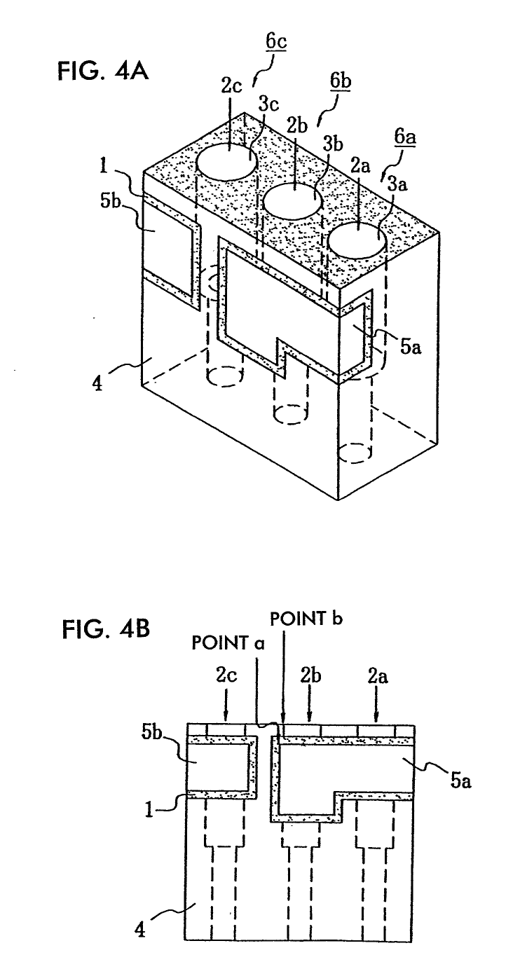

Next, a dielectric filter according to a second embodiment will now be described with reference to FIGS. 3A and 3B and FIGS. 4A and 4B.

FIG. 3A is a perspective view of a dielectric filter, while FIG. 3B is an elevational view of the same.

FIG. 4A is a perspective view of another dielectric filter, while FIG. 4B is an elevational view of the same.

In FIGS. 3A and 3B and FIGS. 4A and 4B, the dielectric filter includes a dielectric block 1, inner-conductor holes 2a, 2b and 2c, inner conductors 3a, 3b and 3c, an outer conductor 4, I/O electrodes 5a and 5b, and dielectric resonators (hereinafter referred to as resonators) 6a, 6b and 6c.

The dielectric filter shown in FIGS. 3A and 3B is formed in the same manner as in the first embodiment, except that the shape of the I/O electrode 5a is modified.

As shown in FIG. 3B, the side-surfaces of the dielectric block 1 are orthogonal to the direction in which the inner-conductor holes 2a to 2c are arrayed. A point a corresponds to a position beyond a side of the inner-conductor hole 2b, that is, the side near the inner-conductor hole 2c. A point b corresponds to a side of the inner-conductor hole 2b, that is, the side near the inner-conductor hole 2c. The I/O electrode 5a extends from one side-surface near the inner-conductor hole 2a to the point a. The width of the I/O electrode 5a, which is parallel to the axial direction of the inner-conductor holes, is smaller at the region where it is coupled with the resonator 6b than at the region where it is coupled with the resonator 6a.

A dielectric filter shown in FIG. 4A is formed in the same manner as in the first embodiment, except that the shape of the I/O electrode 5a is modified. That is to say, the width of the I/O electrode 5a at a region where it is coupled with the resonator 6b is larger than at the region where it is coupled with the resonator 6a.

According to the above-described configurations, the position of an attenuation pole may be changed by changing the coupling capacitance between the resonator 6b and the I/O electrode 5a. Subsequently, the dielectric filter readily and stably exhibits the desired characteristics.

Further, when the width of the I/O electrode 5a at the region where the resonator 6b is connected is narrow, the following effects may be obtained. That is to say, when the I/O electrode 5a becomes long enough to cover the resonator 6a and the resonator 6b, the coupling capacitance obtained becomes much larger than desired. By making the width of the I/O electrode 5a at the region where the resonator 6b is coupled narrow as shown in FIGS. 3A and 3B, the coupling capacitance can be reduced to a desired level.

Although the coupling capacitance can also be adjusted by making the I/O electrode 5a shorter, the change resulting from this method becomes too large. In other words, it is very difficult to achieve fine adjustments simply by making the I/O electrode 5a shorter. However, by adjusting the width of the I/O electrode 5a at the region where it covers the inner-conductor holes as in this embodiment, it is easy to make fine adjustments and to reduce the coupling capacitance to a desired level.

One surface of each of the dielectric filters described in the first and the second embodiments has one of the openings of each of the inner-conductor holes 2a to 2c but no electrodes thereon. Thus, this surface functions as an open end of the dielectric filters. However, other types of dielectric filter according to the present invention are possible. For example, one type of dielectric filter may comprise, on a surface having one of the openings of each inner-conductor hole, coupling electrodes for generating capacitance between the openings of neighboring inner-conductor holes. Another type of dielectric filter may comprise an outer conductor formed on all surfaces of the dielectric block, and, near one of the surfaces which has one of the openings of each inner-conductor hole, each of the inner-conductor holes may have a region where no inner conductor is formed, these regions being provided near said openings of the inner-conductor holes. In this way, the regions of the inner-conductor holes where no conductor is formed function as open ends of the dielectric resonators.

The sectional shape of the inner-conductor holes is not limited to a circle, but may be an ellipse, a polygon and so forth.

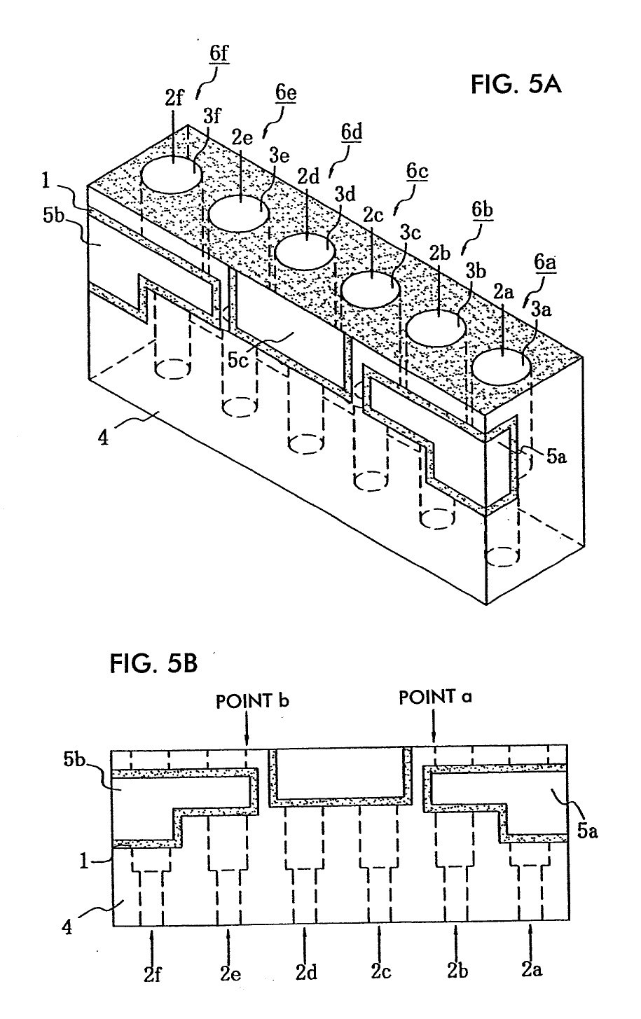

A dielectric duplexer according to a third embodiment will now be described with reference to FIG. 5A and FIG. 5B.

FIG. 5A is a perspective view of the dielectric duplexer, and FIG. 5B is an elevational view of the same.

In FIGS. 5A and 5B, the dielectric duplexer includes a dielectric block 1, inner-conductor holes 2a, 2b, 2c, 2d, 2e, and 2f, inner conductors 3a, 3b, 3c, 3d, 3e, and 3f, an outer conductor 4, I/O electrodes 5a, 5b and 5c, and dielectric resonators (hereinafter referred to as resonators) 6a, 6b, 6c, 6d, 6e, and 6f.

Inside the dielectric block 1, the inner-conductor holes 2a to 2f, having the inner conductors 3a to 3f formed on the surfaces thereof, form resonator electrodes. On the outer surface of the dielectric block 1, the outer conductor 4 forms a ground electrode. In this manner, the inner-conductor holes 2a to 2f and the outer electrode 4 constitute the dielectric resonators 6a to 6f. The I/O electrode 5a extends from one side-surface to the undersurface of the dielectric block 1 and is separated from the outer conductor 4. The side-surfaces are orthogonal to the direction in which the inner-conductor holes are arrayed, and the undersurface faces a mounting substrate (not shown) when the duplexer is mounted. The I/O electrode 5b extends from the other side-surface to the undersurface of the dielectric block 1 and is separated from the outer conductor 4. The I/O electrode 5c is formed only on the undersurface, so as to couple with the resonators 6c and 6d.

In this embodiment, the resonators 6a to 6f are arrayed so that the resonator 6b is positioned to the left of the resonator 6a, the resonator 6c is positioned to the left of the resonator 6b, the resonator 6d is positioned to the left of the resonator 6c, the resonator 6e is positioned to the left of the resonator 6d, and the resonator 6f is positioned to the left of the resonator 6e, when viewed from the undersurface as shown in FIGS. 5A and 5B. Further, as shown in FIG. 5B, a point a corresponds to a side of the inner-conductor hole 2b, that is, the side near the inner conductor 2c, and a point b corresponds to a side of the inner-conductor hole 2e, that is, the side near the inner-conductor hole 2d.

The I/O electrode 5a on the undersurface extends from one side-surface to beyond the point a. The width of the I/O electrode 5a is smaller at the region where it is coupled with the resonator 6b than at the region where it is coupled with the resonator 6a. The width is parallel to the axes of the inner-conductor holes.

The I/O electrode 5b extends from the other side-surface to beyond the point b. The width of the I/O electrode 5b is smaller at the region where it is coupled with the resonator 6e than at the region where it is coupled with the resonator 6f. The width is parallel to the axes of the inner-conductor holes.

Thus, the dielectric duplexer comprises a dielectric block which has a dielectric filter having the resonators 6a and 6b coupled with the I/O electrode 5a, and the resonator 6c coupled with the I/O electrode 5c. The dielectric filter also has another dielectric filter having the resonators 6e and 6f coupled with the I/O electrodes 5b, and the resonator 6d coupled with the I/O electrode 5C.

Accordingly, the resulting dielectric duplexer exhibits desired characteristics, and suitable attenuation characteristics and stable communication characteristics are achieved.

As in the cases of the above-described dielectric filters, the dielectric duplexer may have an open end at a surface having one of the openings of each of the inner-conductor holes, and coupling electrodes on that surface. The duplexer may also be provided with an open end by providing a region where no inner conductor is formed on the surface of each of the inner-conductor holes.

Further, the sectional shape of the inner-conductor holes is not limited to a circle, but may be an ellipse, a polygon and so forth.

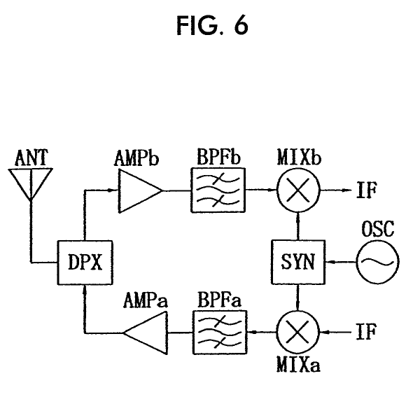

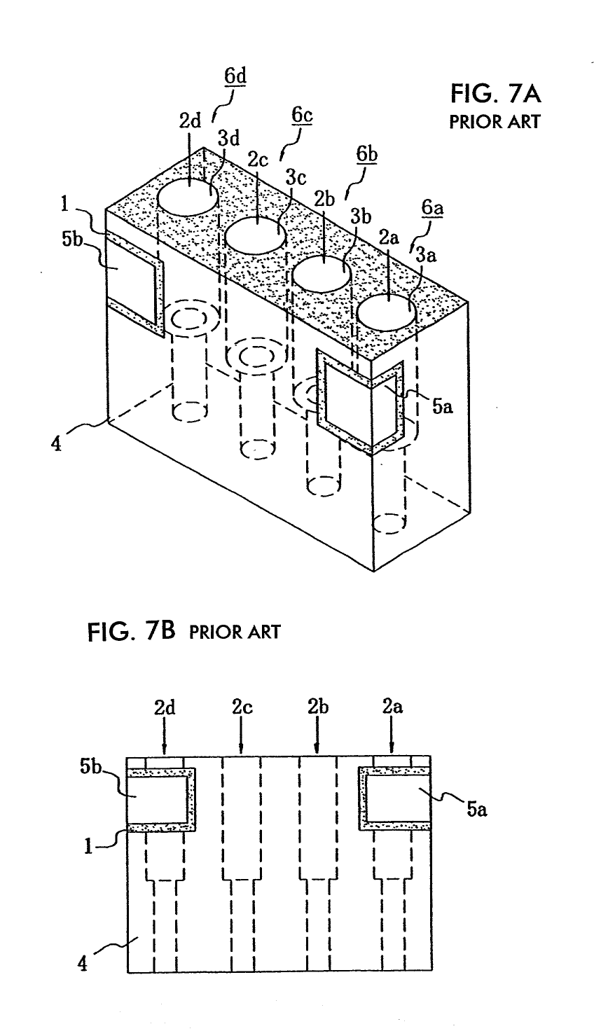

The configuration of a communication device according to a fourth embodiment will now be described with reference to FIG. 6.

In FIG. 6, ANT denotes a transmission/reception antenna, DPX denotes a duplexer, BPFa and BPFb denote bandpass filters, AMPa and AMPb denote amplifier circuits, MIXa and MIXb denote mixers, OSC denotes an oscillator, SYN denotes a synthesizer, and IF denotes an intermediate frequency signal.

As the bandpass filters BPFa and BPFb shown in FIG. 6, the dielectric filters shown in FIGS. 1A and 1B, FIGS. 3A and 3B, and FIGS. 4A and 4B may be used. As the duplexer DPX shown in FIG. 6, the dielectric duplexer shown in FIGS. 5A and 5B may be used. The communication device offers predetermined communication performance by comprising the dielectric filters and the dielectric duplexer having desired characteristics for achieving suitable and stable attenuation.

Although the present invention has been described in relation to particular embodiments thereof, many other variations and modifications and other uses will become apparent to those skilled in the art. Therefore, the present invention is not limited by the specific disclosure herein.

What is claimed is:

1. A dielectric filter comprising:
a substantially rectangular parallelepiped dielectric block;
a plurality of inner-conductor holes extending from a top surface to an opposing bottom surface of the dielectric block;
an inner conductor provided on the respective surface of each of the inner-conductor holes;
an outer conductor formed on outer surfaces of the dielectric block; and
I/O electrodes extending from side-surfaces to an undersurface of the dielectric block, the side-surfaces being orthogonal to a direction in which the inner-conductor holes are arrayed in the dielectric block, and the undersurface being a mounting surface for being mounted on a mounting board,
wherein the I/O electrodes are separated from the outer conductor, and
at least one of the I/O electrodes extends onto the undersurface of the dielectric block so as to overlie at least two of the inner-conductor holes when viewed from the undersurface.

2. A dielectric filter according to claim 1, wherein said at least one of the I/O electrodes has a width which is different between a first region corresponding to a first one of the two inner-conductor holes and a second region corresponding to the second one of said two inner-conductor holes when viewed from the undersurface.

3. A dielectric filter according to claim 2, wherein the width at the first region is larger than the width at the second region.

4. A dielectric filter according to claim 2, wherein the width at the first region is smaller than the width at the second region.

5. A dielectric duplexer comprising a pair of dielectric filters, one of said filters being a dielectric filter as described in claim 1.

6. A communication device comprising at least one of a transmitting circuit and a receiving circuit, said circuit comprising a dielectric filter as described in claim 1.

7. A dielectric filter according to claim 1, wherein said outer conductor is formed on all of said outer surfaces of said dielectric block except said top surface.

8. A dielectric filter according to claim 7, wherein said inner conductors are connected to said outer conductor at said bottom surface.

9. A dielectric filter according to claim 2, wherein said second region extends to a point beyond said second inner conductor hole in a direction away from the corresponding said side-surface.

10. A dielectric filter according to claim 1, wherein said at least one I/O electrode extends from the corresponding said side-surface to a point beyond said second inner-conductor hole in a direction away from the corresponding said side-surface.

11. A dielectric filter comprising:
a substantially rectangular parallelepiped dielectric block;
a plurality of inner-conductor holes extending from a top surface to an opposing bottom surface of the dielectric block;
an inner conductor provided on the respective surface of each of the inner-conductor holes;
an outer conductor formed on outer surfaces of the dielectric block; and
I/O electrodes extending from side-surfaces to an undersurface of the dielectric block, the side-surfaces being orthogonal to a direction in which the inner-conductor holes are arrayed in the dielectric block, and the undersurface being a mounting surface for being mounted on a mounting board,
wherein the I/O electrodes are separated from the outer conductor, and
at least one of the I/O electrodes is disposed in such a position on the undersurface of the dielectric block as to couple to at least two of the inner-conductor holes.

12. A dielectric filter according to claim 11, wherein said at least one of the I/O electrodes has a width which is different between a first region corresponding to a first one of the two inner-conductor holes and a second region corresponding to the second one of said two inner-conductor holes when viewed from the undersurface.

13. A dielectric filter according to claim 12, wherein said second region extends to a point beyond said second inner conductor hole in a direction away from the corresponding said side-surface.

14. A dielectric filter according to claim 12, wherein the width at the first region is larger than the width at the second region.

15. A dielectric filter according to claim 12, wherein the width at the first region is smaller than the width at the second region.

16. A dielectric filter according to claim 11, wherein said at least one I/O electrode extends from the corresponding said side-surface to a point beyond said second inner-conductor hole in a direction away from the corresponding said side-surface.
